(19) United States
(12) Patent Application Publication
(10) Pub. No.: US 2008/0219031 A1
(43) Pub. Date: Sep. 11, 2008

(54) Apparatus and methods for improving the transient response capability of a switching power supply

(76) Inventors: KENT KERNAHAN, CUPERTINO, CA (US); SORIN ANDREI SPANOCHE, SANTA CLARA, CA (US); JINGQUAN CHEN, SAN JOSE, CA (US)

Correspondence Address: MICHAEL W. CALDWELL, 4226 RIVERMARK PARKWAY, SANTA CLARA, CA, 95054-4150, US

(21) Appl. No.: 11/682,338

(22) Filed: Mar. 6, 2007

(51) Int. Cl. H02M 3/335

(52) U.S. Cl. 363/21.01

(57) ABSTRACT

The transient response of a switching power supply is improved by providing one or more supplemental power sources connected to the output terminal of the power supply. In one embodiment additional current is provided when a sudden increase in load current causes a corresponding decrease in output voltage. In one embodiment current is discharged when a sudden decrease in load current causes a corresponding increase in output voltage. The supplemental power sources provide a fixed current for a fixed duration. In one embodiment the current provided from the power sources is variable according to the increase or decrease in load current. In some embodiments the supplemental current is provided for a time period approximating the time required for the switching power converter coil current to equal the new load current.

### BACKGROUND

A switching power converter regulates an output voltage by intermittently connecting a power source, such as a battery, to a load. A low pass filter, comprising a series coil and a parallel smoothing capacitor provides reduction of the ripple in the output voltage resulting from the intermittent connection. Referring to FIG. 1, the basic operation of a buck switching power converter is the intermittent connection between an input voltage “Vin” provided by some power source at input terminal 102, and a coil 120 by a control FET 102 (“UFET” for a time termed “Tp” after which a synchronizing FET 104 (“LFET” is turned off and a synchronizing FET 116 is turned on for a time termed “Ts”. This is accomplished by a controller 142 generating appropriate signals in accordance with the Tp and Ts parameters on lines 140 and 142 connected to the control gates of FETs 102 and 104. This causes current “Icoil” to flow through coil 120 to load Rload 134. Output voltage “Vo”, measured at output terminal 1, is smoothed by a capacitor Co. FET 104 may be replaced by a diode to form a non-synchronous buck supply, in which case line 142 is not needed. In a non-synchronous topology Ts is the time during which the current from coil 120 continues to flow after FET 102 is turned off. Said differently, it is the time required for the current to return to zero or some minimum value after time Tp is completed. Those skilled in the art will recognize that some embodiments of the present invention may be applied to any switching power converter topology, including but not limited to buck, boost, and buck/boost wherein any of them may be implemented as synchronous or non-synchronous designs. Tp and Ts are calculated during one time period Tn and applied during the next time period Tn+1. We will sometimes write T(n) for Tn, T(n+1) for Tn+1, etc.

Due to the limited rate at which current from a coil can be increased or decreased, the ability of a switching power converter to respond to a transient condition, such as a sudden increase or decrease in the current demand of the load, is time limited. For a switching power converter comprising a digital controller, wherein the digital controller regulates the output voltage Vo by calculating responses based upon digital data, for example periodic analog to digital conversions of samples of the output voltage, the response time to a transient condition may be further extended by the time period between samples.

Transient response time is an important factor in the suitability of a specific power converter design for a specific application. As transient response time increases, the anticipated excursion of output voltage from a target voltage value in response to the transient load condition increases. For example, consider a transient condition wherein the current demand of the load suddenly increases. The output voltage will decrease until the power converter can provide extra current through the coil 120 to halt the decrease in voltage, then finally return the voltage to the desired target value. The load will have a certain minimum voltage for proper operation. As a result the target voltage may be designed to be higher than needed during steady state operation to allow for a maximum decrease in output voltage due to a load transient. A higher target (therefore, average) voltage results in the load consuming more power than necessary during steady operation. Said differently, a faster transient response may allow the target voltage to be set lower, thereby lowering the average power consumption of the load, without output voltage momentarily dropping below the desired minimum.

In the case of a sudden decrease in load current the output voltage will experience an excursion to a higher output voltage. Extra charge is stored in the coil, and the only means for decreasing the excess charge is dissipating it through the load. If the load is now small, the voltage may become high enough to cause damage to the load. To guard against an over voltage condition, the target voltage may be set to the low side of that needed for proper operation of the load, but which may also aggravate the ability of the power converter to respond to a sudden increase in the load current demand, which would result in a voltage sag.

What is needed is a power converter which provides fast transient response such that the target voltage may be set near a minimum design value for proper operation of the load while also providing for a narrow range between the maximum and minimum voltages.

### SUMMARY

In a switching power converter, charge is provided to and stored on an output smoothing capacitor by operation of an upper FET and a lower FET through a coil, while charge is simultaneously being removed from the smoothing capacitor by a load. As previously described herein, charge may suddenly be removed from the smoothing capacitor more quickly than it can be supplied, resulting in a drop in net charge, hence voltage, on the capacitor. The present invention supplements the charge-providing capacity of the coil by momentarily providing a selectable supplemental energy source directly connected to the smoothing capacitor. When a drop in output voltage, which is the same as the voltage on the capacitor, is in excess of a predetermined value, the supplemental energy source is selected to provide a quantity of make-up current, thereby supplementing the instant current provided by the coil.

In one embodiment the switching power converter controller detects a drop in output voltage (“sag” and responds by changing the duty cycle of the upper FET while also selecting the supplemental energy source, the supplemental energy source mitigating the effect on output voltage by the transient increase or decrease in the load current. In one embodiment the mechanism for triggering the supplemental energy source operates independently of the switching power converter control system. The supplemental energy source may provide a predetermined, fixed value of current for a predetermined, fixed time period. In some embodiments a control algorithm calculates the value of the supplemental current and its time duration as a function of the instant input and output voltages, rate of change of the output voltage, and known or calculated values of the coil and smoothing capacitor and their parasitics.

In some embodiments a current source is provided which will remove charge from the smoothing cap in response to a sudden decrease of load current, thereby to mitigate an over voltage condition (“surge”.

### BRIEF DESCRIPTION OF THE DRAWINGS

FIG. 1 is an example circuit for a synchronous regulator with supplemental current sources in accordance with the present invention.

FIG. 2 is a graph of a smoothing capacitor voltage over a time period wherein the voltage responds to various current sources.

FIG. 3 is a detailed graph of a transient load change, coil current, and a supplemental current.

FIG. 4 is a detailed graph of a change in output voltage in response to a change in load.

FIG. 5 is a simulation of response by a switching power converter to a transient increase in load.

FIG. 6 is a simulation of response by a switching power converter to a transient increase in load, wherein the method of the present invention is used.

FIG. 7 is a simulation of response by a switching power converter to a transient decrease in load.

FIG. 8 is a simulation of response by a switching power converter to a transient decrease in load, wherein the method of the present invention is used.

FIG. 9 shows a method for determining the value of a smoothing capacitor and the value of the equivalent series resistance of the capacitor.

FIG. 10 shows various embodiments of supplemental energy sources.

### DESCRIPTION OF SOME EMBODIMENTS

### Definition of Terms

| | |
|---|---|
| CCM | Continuous Coil Current Mode |
| DCM | Discontinuous Coil Current Mode |
| dX | Change in value of X, where X may be any parameter such |
| | as I, V, Tp, Ts, etc. |
| Icoil | Coil current |
| Tp, tp | Time period during which a control (“high side”) FET is |
| | turned on. |
| Ts, ts | Time period during which a synchronizing (“low side”) FET is |
| | turned on, or during which a corresponding diode conducts. |
| UFET | “High side” FET in a switching power converter |
| LFET | “Low side” FET in a switching power converter |

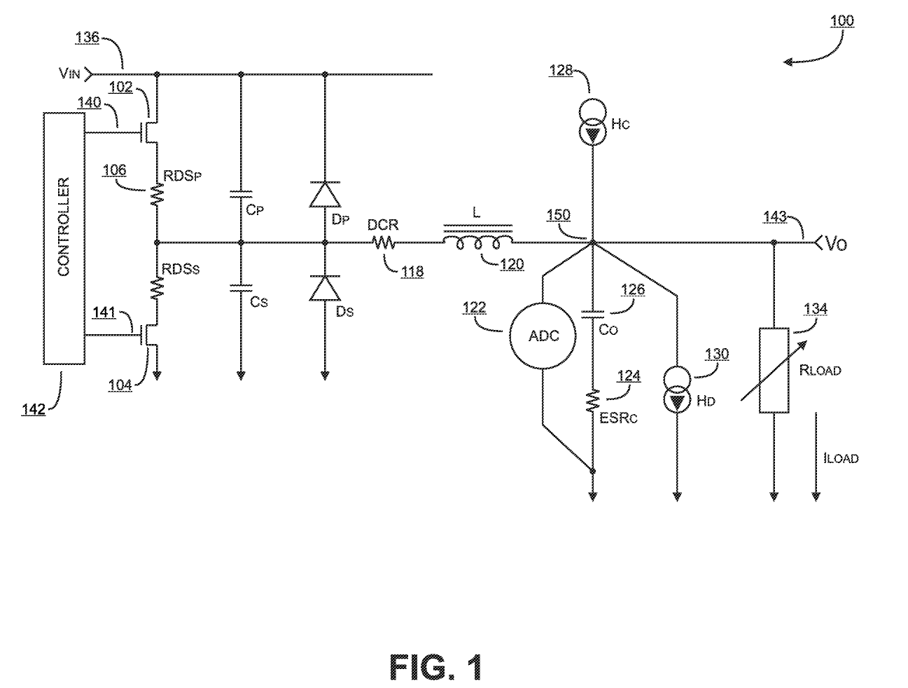

FIG. 1 shows a typical switching power converter combined with a supplemental energy source 128 and a supplemental energy drain 130, forming a voltage regulation system 100 in accordance with the present invention. The switching power converter is a synchronous regulator type, wherein a source of voltage provided at an input terminal 136 is momentarily connected to a load 134 as a result of a signal on line 140 of duration Tp driving the control gate of a transistor 102. The duty cycle of the regulation system 100 is defined as (Tp/T), wherein T is a frame time between Tp events. A low pass filter, comprising a coil 120 and a smoothing capacitor 126, reduces the magnitude of ripple on the output voltage Vo.

The system 100 shown is a synchronous regulator type, wherein a synchronizing transistor 104 connects the coil 120 to ground for a time Ts when a signal on line 142 drives the transistor 104 control gate. The transistors 106 and 104 are not turned on at the same time. In some embodiments an analog to digital converter (“ADC”, for example the ADC 122, measures Vo across the smoothing capacitor 126 and provides a digital representation of the value of the voltage V0 to the controller 142. A control loop controlling the programmable controller 142, responsive to the value of Vo relative to a target voltage or to other predetermined voltage value limits, determines the value of the time duration Tp that will maintain or restore the output voltage Vo to a target value. FIG. 1 details some of the parasitics of the components used, for example the equivalent series resistance 124 (“ESRc” of the capacitor Co 126 and the direct current resistance 118 (“DCR” of the coil 120.

The circuits and methods to be disclosed are applicable to improving a power converter's response to either a sudden increase or a sudden decrease in current in the load Rload 134. The following discussion will disclose various circuits and methods applicable to a response to a sudden increase (“transient”) in the load current. The circuits and methods to be discussed are equally applicable to a sudden decrease in load current. A switching power converter is expected to encounter some positive and negative changes in the power demands of the load, which result in variations in the output voltage. In one embodiment a switching power converter is designed for transients of a certain value. A transient in excess of the design value (that is, output voltage Vo departs from a desired value by a predetermined amount) is termed a “trigger” event. The controller 142 responds to the trigger even by implementing the method of the present invention, using the apparatus needed (as shown in FIG. 1) by the method.

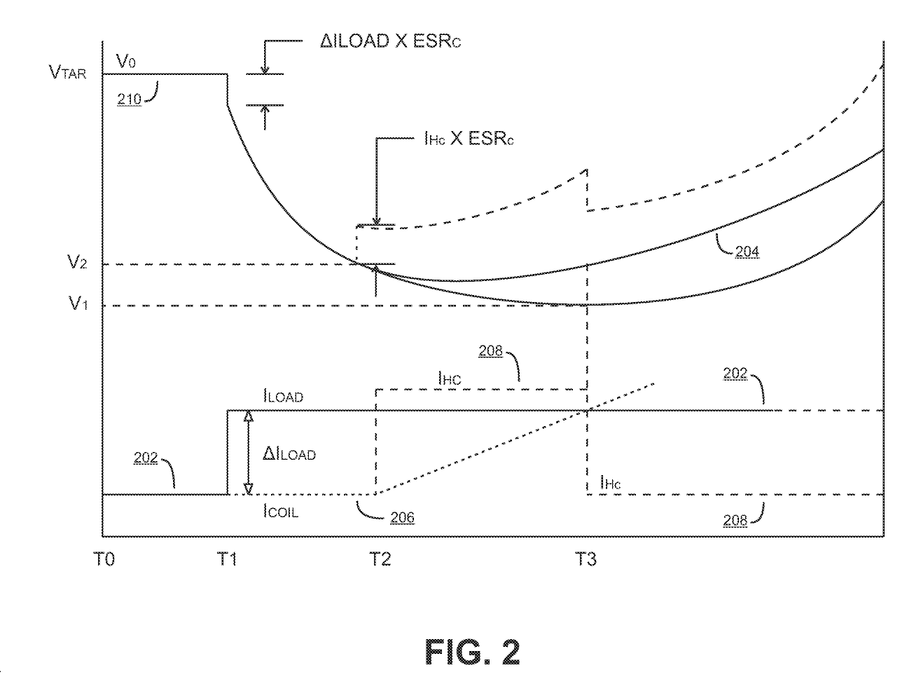

FIG. 2 illustrates the relationships over time between a current Iload 202 through the load Rload 134, a current Icoil 206 through the coil 120, and the current Ihc 208 provided by energy source Hc 128. First we consider response to a transient without benefit of the present invention. At a time T0 the load current Iload 202 is in equilibrium with the average current Icoil 206 provided by coil 120, which results in a relatively steady output voltage Vo as measured at output terminal 140. For simplicity of explanation, any ripple current on Vo in the region shown as 210 on FIG. 2 is disregarded. At time T1 an ideal step of ΔIload in load current Iload 202 causes an immediate drop in voltage Vo. The drop in output voltage Vo is the result of the change in current ΔIload, which is provided by the smoothing capacitor 126 times the equivalent series resistance 124 (“ESRc” of the capacitor 126. Vo voltage continues to drop until time T2, the result of the excess load current Iload relative to the current provided by the coil 120. In the worst case, the ADC 122 has digitized the value of the output voltage Vo just before the time T1. At time T2 the ADC 122 takes digitizes the output voltage Vo and provides the result to the controller 142. Controller 142 at time T2 knows that the output voltage Vo has dropped and in response drives the gate of UFET 102 for a time Tp, wherein Tp is now a longer duration than in the previous T time. In some embodiments UFET is driven to its ON condition for a time longer than the time T. This response is denominated an “emergency duty cycle.” Coil 120 current Icoil 206 begins to ramp up, finally equaling the load current Iload at a time T3. The traces of FIG. 2 are illustrative, and may not be to scale for a given transient/response. For example, the time duration (T3−T2) may be more or less than the frame duration time T. Between the times T2 and T3 the coil 120 current 206 is increasing but is less than the load current Iload 202, thus output voltage Vo continues to decrease, though as a lesser rate as Icoil 206 increases. At time T3 Icoil 206 equals Iload 202 and voltage stops decreasing. Depending upon the system 100 design, operational needs of the load Rload 134, and the control loop implemented within the controller 142, the coil 120 current 206 may be driven above the load current Iload 202 until such time as the output voltage Vo increases to the desired value. For example, Vo may be driven to a target nominal voltage or a predefined minimum voltage. The minimum value of output voltage during the response to the transient in load current is annotated on FIG. 2 as the value V1.

Now we consider a transient response in accordance with the present invention. At time T2 the controller 142, in addition to driving the gate of the UFET 102 to ramp coil 120 current Icoil, selects a supplemental energy source Hc 128. Hc 128 provides an ideally immediate increase in current Ihc at the node 150 (FIG. 2), wherein node 150 is in common with the high voltage side of capacitor 126, the high voltage side of the load Rload 134, and output terminal 140. Depending upon the absolute value of current, printed circuit board trace lengths and geometry and material, and parasitic factors, some voltage drop may occur between these elements (capacitor 126, energy source 128, output voltage Vo, and the voltage across the load Rload 134), which will be assumed small and therefore ignored for the purposes of this disclosure.

FIG. 2 illustrates one embodiment wherein the value of incremental current provided by energy source Hc 128 is somewhat greater than ΔIload. The currents Icoil 206 and Ihc 208 are additive, therefore (Icoil+Ihc)>Iload (at time T3) and output voltage Vo immediately begins to increase. The minimum output voltage is improved (over the minimum V1) to V2. Said in another way, the present invention, by injecting extra energy at a point ideally immediately available to the capacitor 126 and therefore load Rload 134, stops the voltage-decreasing effect of a load transient as soon as such condition is detected by the controller 142.

As was the case at the time T1, at time T2 the voltage immediately increases by an amount equal to the increase in current (Ihc) times ESRc 124. In the scenario illustrated by FIG. 2 Ihc is provided to the load Rload 134 until the coil 120 current 206 equals the load current 202. At time T3 the supplemental current Ihc 208 is turned off, and again we see an incremental change in output voltage equal to Ihc*ESRc.

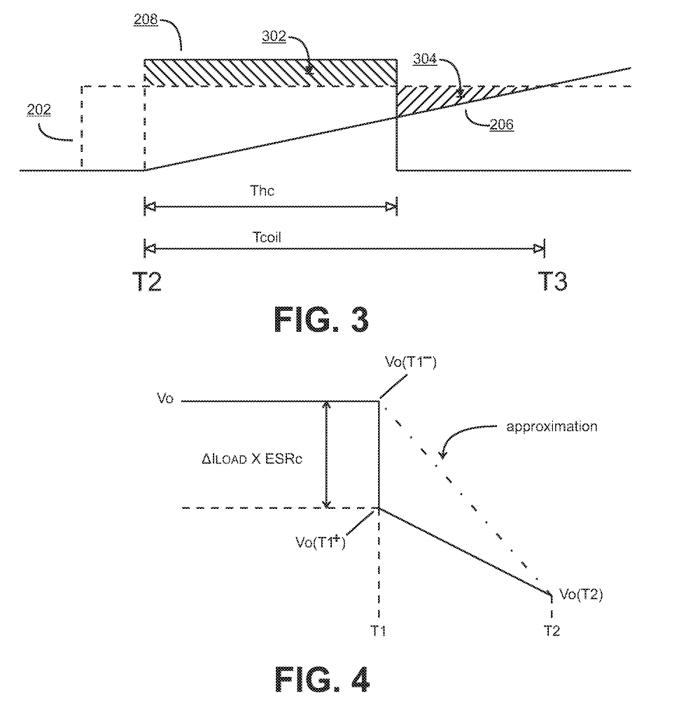

Other scenarios will be obvious to those skilled in the art. For example, if the step increase in Ihc 208 is less than ΔIload, output voltage will continue to decrease at time point T2, although at a slower rate than if Ihc were not provided. The energy provided by the increasing coil current is approximated by the area under the curve over the time applied. Likewise the energy provided by Ihc is approximated by the area under the curve of the increase in Ihc for its duration. FIG. 3 represents the condition wherein the current Ihc 208 is greater than the in load current ΔIload, shown by line 202. The duration of the pulse or current Ihc, shown by line 208, is less than the time required for the increasing current 206 of coil 120 to equal the higher current 202 of the load Iload. The area shown as 302 equals the difference between the supplemental current 208 and the load current 202 times the time duration of the pulse of Ihc, Thc. This area 302 increases the output voltage during the time shown. The area indicated as 304 represents the difference between the load current 202 and the increasing coil current 206 during the time period (Tcoil−Thc). If the area 302 is less than the area 304 the output voltage at the end of the time period Tcoil, also shown as time point T3 on FIG. 2, will be less than the output voltage at the time T2 (FIG. 2). To insure that the output voltage does not go below the output voltage at the time T2, area 302 must be equal to or greater than area 304, assuming the ideal wave forms shown in FIG. 2 and FIG. 3, including the assumption that the load Rload 134 current Iload is constant in the window shown.

The operational benefit of the present invention lies in the difference between V2 and V1. A power supply is designed such that a load transient will not result in an output voltage of less than a predetermined value. The maximum voltage reduction that a certain system design will allow (under specified conditions) may be added to the predetermined minimum value to determine the target voltage. If a system 100 design is such that a transient load increase will not result in a voltage lower than V2 during recovery, the target voltage for Vo (Vtar on FIG. 2) may be decreased by the amount (V2−V1) with a corresponding reduction in energy taken from the power source for the system on an ongoing basis.

In one embodiment fixed values for Ihc and Thc are predetermined. If Ihc is too little for the instant conditions, V2 will be higher than V1, but output voltage will continue for a time below the output voltage at the time T2. However, Ihc must be determined carefully; if Ihc is too much greater than ΔIload an over-voltage and/or limit cycle may result. In one embodiment a fixed Ihc is predetermined wherein the fixed Ihc coincidental with a trigger condition resulting from a minimum ΔIload will not result in an over voltage spike, accepting that a larger increase in load current will result in some additional decrease in output voltage. Fixed values of Ihc and Thc provide an exact solution to a transient condition, but provide a degree of improvement and rather simple to implement.

In some embodiments the system 100 includes another supplemental energy source Hd 130. Energy source 130 is connected such that it removes (discharges) charge from capacitor 126. Energy source 130 is used in the case of a sudden decrease of current in the load Rload, such as may occur when a device powered by voltage provided at terminal 140 is turned off, put in a low power mode, or removed altogether. To prevent an over voltage condition energy source Hd removes charge from the capacitor 126 in the same manner as that previously described for a sudden increase in load current and is not discussed further herein. In one embodiment both Hc 128 and Hd 130 are provided, such that the total maximum to minimum output voltage swing is diminished. In some embodiments only Hc 128 or Hd 130 are used. In one embodiment the supplemental energy value and pulse width are fixed for a certain unit. In another embodiment the supplemental energy value and pulse width are programmable prior to being used, and are fixed thereafter.

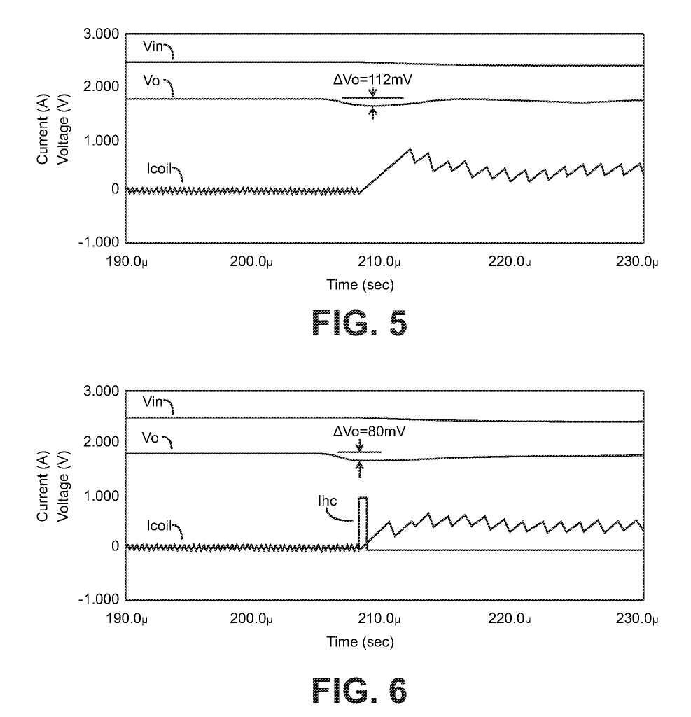

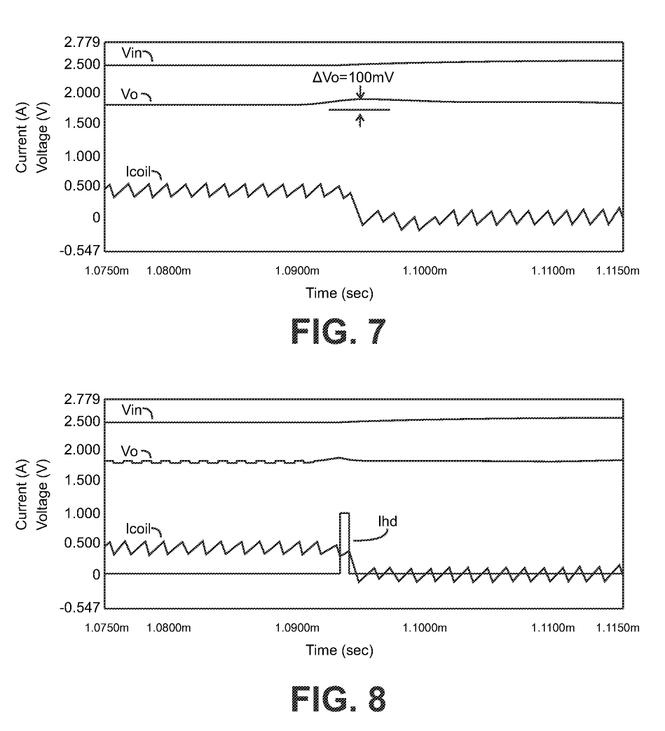

FIG. 5 through FIG. 8 are simulations showing the effect of the method of the present invention, wherein a fixed Ihc and Ihd are provided to the load for a fixed time Thc and Thd, respectively. The analysis reflects a switching power converter using a coil 120 of 3.3 uH, a smoothing capacitor 120 of 12 uF, at a switching frequency of 680 KHz. The input voltage is 3.0 v, and the output voltage is targeted for 2.5 volts. In each case a load transient of 400 mA is applied. When the control loop of the system 100 detects a triggering event, the UFET 102 is driven ON. In FIG. 5 the coil current increases to return Vo to its target value. A Vo sag of 112 mVolts is seen due to the ramp time of the coil current. In FIG. 6, under the same conditions, a supplemental pulse of 1.0 amp is provided to the capacitor Co 126 for 0.6 uSec. The output voltage Vo sag is 80 mVolts, an improvement of 42 mVolts. In FIG. 7 the load current is suddenly decreased by 400 mVolts and a surge on Vo of 100 mVolts results. In FIG. 8, a supplemental discharge pulse of 1.0 amp is applied for 0.6 uSec and the resulting voltage surge is 77 mVolts, a 23 mVolt improvement.

An appropriate value for Ihc and its time duration Thc such that a transient is always stopped when a reaction is triggered (within the limits of measurement; capacity of the components used; unknown component variation with time, temperature; and other factors) may be calculated if the values of the voltage (“Vin” available to the switching power converter and the output voltage at terminal 140 are known. Ideally, as may be seen from FIG. 2, Ihc=ΔIload and Thc is the time required for the coil current to increase to the point that it equals the load current. If Ihc is greater than ΔIload and over voltage may result. If Ihc is less than ΔIload, output voltage will not be stopped at the trigger time. If Ihc exactly equals ΔIload but Thc continues after the time that the coil 120 current equals the load Rload 134 current an over voltage condition may result; no benefit derives from Thc extending past the point shown on FIG. 2 as T3. If Thc is less than the time T3 output voltage will begin to go back down until the coil 120 current equals load current.

FIG. 4 details a transient at time T1 as previously described. Assuming the value of the capacitor 126 is known, we can find the value of ΔIload by knowing the change in output voltage by:

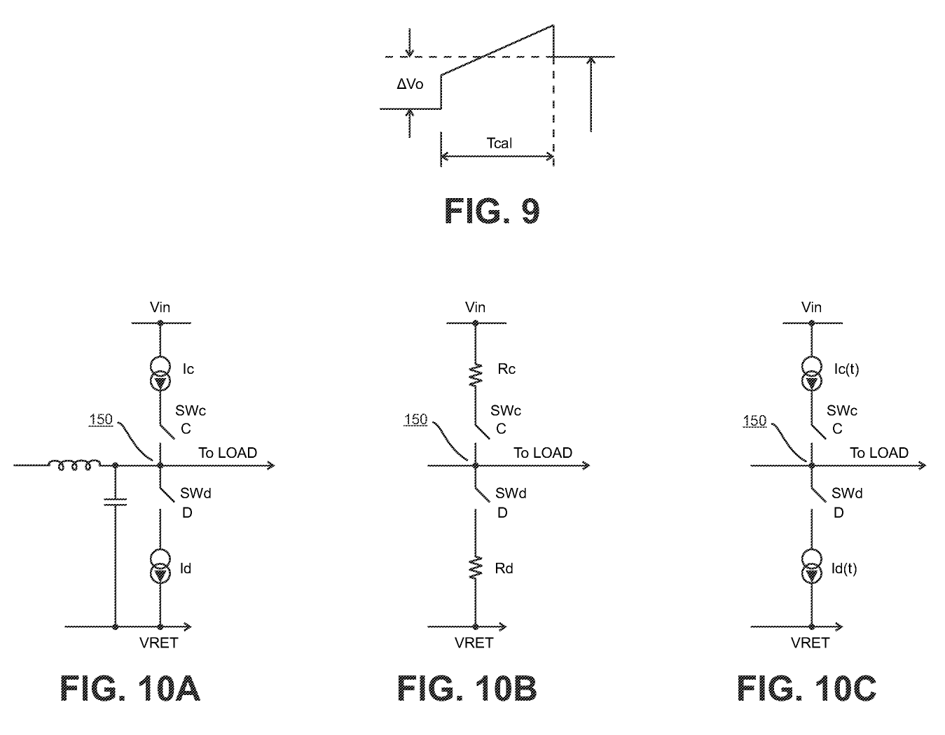

ΔIload=Co(dV/dT) (1)

where dV is the difference between Vo(T2) and Vo(T1+). Vo(T1+) is the voltage immediately after the increase in load current and is less than Vo(T1−) by an amount equal to ΔIload*ESRc. If the ESRc 124 of the capacitor 126 is disregarded or not known, equation (1) will result in a value for Ihc that is greater than that needed to initially stop Vo from going down while coil 120 current is catching up. In one embodiment the values of capacitance and ESRc are taken from the datasheet for the capacitor 126 employed. In one embodiment, to improve accuracy and respond to changes due to component aging and temperature, the capacitance Co of capacitor 126 is calculated. FIG. 9 illustrates the change in output voltage due to a calibration pulse of current of value Ihc for a time duration of Tcal. Voltage measurements (Vo) are taken immediately before and after the calibration pulse. If the value of Ihc is known, for example the current from a constant current source of reasonable accuracy, we find the value of Co by the following steps:

C=QV and Q=I*T by definition, where

V=ΔVo, I=Ihc, T=Tcal, and C=Co, so we find:

Co=(Ihc*Tcal)/ΔVo. (2)

Note that the offset caused by the current through the ESRc 124 is canceled out by evaluating Vo before and after the application of the Ihc pulse. Since dT is known (Tcal) and ΔVo is measured, Co can be determined. Now that Co is known, ESRc 124 may also be determined. Note that in finding Co we did not learn the offset of the voltage curve, only the change during the time Tcal. A third voltage measurement is taken at a time point Tcal/2. We then find ESRc by:

ESRc=(Vy−ΔVo/2)/Ihc, (3)

where Vy is the output voltage at time Tcal/2 and ΔVo is the measured change in voltage during the time period Tcal. By subtracting out the change in voltage due to the capacitance from the total change in voltage we are able to determine the voltage drop caused by ESRc 124. The third voltage measurement may also be taken at a time point different than Tcal/2 and equation (3) scaled accordingly. In some embodiments the calibration of Co and ESRc is done at the time of system startup, the values saved to memory and used throughout the time of operation. In other embodiments Co or ESRc is recalibrated from time to time to provide a more accurate value for the instant conditions.

Looking again to FIG. 4, we can find the approximate value of Ihc needed to stop the output voltage from going down any further by the following:

$$\begin{matrix}Vo ( T 2 ) - Vo ( T 1 \text{-} ) = Δ Iload * ESRc + ( Δ Iload * Δ T ) / C ; & ( 4 ) \\ = Δ Iload ( ESRc + Δ T / C ) ; therefore & ( 5 ) \\ Ihc = Δ Iload = Δ Vo / ( ESRc + Δ T / C ) , & ( 6 )\end{matrix}$$

where ΔT is the time period (T3−T2) and ΔVo=(Vo(T1−)−Vo(T2)).

The value of Ihc found in equation (6) provides an increase in current equal to the increase in load current such that output voltage is initially stopped from decreasing. The voltage will continue to increase as current from coil 120 is added to the current Ihc. To prevent output voltage from going back down, Ihc is provided for a time Thc, defined as the time period from the trigger point (for example T2) until the coil 120 current equals the load current (shown as T3).

With Ihc known from equation (6) and knowing that Ihc=ΔIload, we may now find the time Thc, using:

Thc=dT=L*Ihc/(Vin−Vo). (7)

The value of inductance L of coil 120 is approximately known from the datasheet. Vin and Vo may be measured by an ADC, for example ADC 122 (the connection of ADC 122 to input terminal 136 is not shown). Note that when Vin and Vo are close, Thc becomes very large. That is, Hc 128 is providing nearly all of the energy required to recover from the transient load condition.

In one embodiment the inductance value of the coil 120 and the direct current resistance (“DCR” of the coil 120 are calculated. The steps of the method used are:
1. Measure an initial voltage on the smoothing capacitor Co 126.
2. Inject a pulse through the coil 120 of time T1 than connects one end of the inductor to Vin. We assume that the on-resistance of UFET 106 is small compared to the DCR of the coil 126.
3. Measure the resulting voltage across capacitor Co 126 immediately after the pulse has terminated.
4. Ideally the current went from zero to Imax which is T1*(V/L) which means that the charge can be approximated as the area of a right triangle Imax high and T1 wide (B*H/2) or T1*(V/L)/2. The change in the capacitor Co 126 voltage will be the charge divided by the capacitance. Since we know the capacitance of Co, T1, and V we can solve for L.
5. To determine the DCR of the coil, we repeat the above process from step 2 for a time T2.
6. If there is DCR in the coil's path to Vin there will be a discrepancy in the calculated L because the higher the current to which the coil 120 is charged the lower the voltage available to L due to increasing drop (due to I*R) across the DCR is effectively in series with the ideal inductance L of the coil 120. This voltage drop is an exponential on T and an exponential is a one to one function on T. Since we have two equations for the two charges transferred to the known capacitor and two unknowns (L, and DCR) there will be a single value of L and of DCR which satisfies for both charges and plus all other resistances in series with the coil during charging (UFET RDSon 106, traces, capacitor ESRc 124, etc).

In some embodiments Ihc is calculated from equation (6) and Thc is calculated from equation (7) for each trigger event. The value of Ihc found in equation (6) assumes that the load transient started at precisely time T1 (FIG. 4). Because Vo is measured periodically, the exact time of the onset of the load transient is not known. For example, if the onset of the load transient started later than T1, equation (6) would estimate a value for Ihc that is less than ΔIload, though of some benefit in diminishing the rate at which Vo is decreasing. In some embodiments the value of Vo at time T2 is compared to the value of Vo at the next sampling time and Ihc (and Thc) recalculated. The voltages are now associated with known time points and a more accurate calculation made for Ihc and Thc from equations (6) and (7), respectively.

The supplemental energy sources Hc 128 and Hd 130 are embodied in a variety of implementations. Referring to FIG. 10, three examples are shown. In each case the additional power may come from Vin (as shown) or from a different power source. Example A embodies constant current sources selectively connected to node 150 (FIG. 1) by switch SWc or switch SWd, wherein Ic provides additional charge to the load or Id discharges the load when the appropriate switch is closed. Example B embodies resistors selectively connected to node 150 by closing switch SWc or closing switch SWd. Example C embodies current sources which are designed to provide less current as the coil 120 current rises when Ic(t) is connected by closing the switch SWc or It(d) is connected by closing the switch SWd.

The charging means and discharging means may be of different types. In one embodiment the charging means and discharging means are designed for different energy-providing values.

The power available from a switching power converter is at its maximum when (Vin−Vo) is a maximum. As Vin and Vo become close in value, a switching power converter has little ability to regulate the output voltage. DCM is more efficient than CCM, but CCM offers more power capacity. A common strategy, then, is to use DCM when (Vin−Vo) is favorable and to transition to CCM when input and output voltage approach each other. In one embodiment of the present invention the ability of a switching power converter to operate in DCM is extended to smaller values of (Vin−Vo) by supplementing the coil 120 current-providing capability. Looking to FIG. 1, ADC 122 measures the output voltage Vo and the input voltage Vin (connection not shown), providing the representations of the voltages to the controller 142. An embodiment of the charge-providing element Hc 128 is used wherein the current Ihc is controlled by the controller 142 (connection not shown). The controller 142 controls Hc 128 to provide its maximum power output when (Vin−Vo) approaches zero volts and the controller 142 controls Hc 128 to provide a minimum (or no) power output when (Vin−Vo) is a maximum value. In one embodiment the current Ihc is provided at node 150 during the time period Tp, defined as the drive time of a signal from controller 142 on line 140 to the control gate of UFET 102. The result is an apparent increase in the power of the coil 120. The control loop of the switching power converter does not need to be changed; the control loop cannot tell that an Ihc event has occurred, rather the coil 120 simply appears to be more powerful to the control loop than the coil 120 actually is. Other means whereby the current Ihc is inversely proportional to (Vin−Vo) may also be used.

Reservation of Extra-Patent Rights, Resolution of Conflicts, and Interpretation of Terms

After this disclosure is lawfully published, the owner of the present patent application has no objection to the reproduction by others of textual and graphic materials contained herein provided such reproduction is for the limited purpose of understanding the present disclosure of invention and of thereby promoting the useful arts and sciences. The owner does not however disclaim any other rights that may be lawfully associated with the disclosed materials, including but not limited to, copyrights in any computer program listings or art works or other works provided herein, and to trademark or trade dress rights that may be associated with coined terms or art works provided herein and to other otherwise-protectable subject matter included herein or otherwise derivable herefrom.

Unless expressly stated otherwise herein, ordinary terms have their corresponding ordinary meanings within the respective contexts of their presentations, and ordinary terms of art have their corresponding regular meanings

If any disclosures are incorporated herein by reference and such incorporated disclosures conflict in part or whole with the present disclosure, then to the extent of conflict, and/or broader disclosure, and/or broader definition of terms, the present disclosure controls. If such incorporated disclosures conflict in part or whole with one another, then to the extent of conflict, the later-dated disclosure controls.

We claim:

1. A switching power converter with enhanced transient load response characteristics, comprising:
a switching power converter comprising:
an input terminal for receiving power from a power source;
an output terminal electrically connected to a load;
a high side FET electrically connected in series between the power source and a coil wherein said coil is electrically connected in series between said high side FET and said output terminal;
an output smoothing capacitor electrically connected to the output terminal in parallel with the load; and
a controller for controlling an on and an off time of the high side FET; and
one or more means for changing the magnitude of charge stored on the smoothing capacitor.

2. The switching power converter of claim 1, wherein the one or more means for changing the magnitude of charge comprises a constant current source wherein the constant current source is electrically connected to the smoothing capacitor.

3. The switching power converter of claim 1, wherein the one or more means for changing the magnitude of charge comprises a resistor wherein a first terminal of the resistor is electrically connected to a power source and a second terminal of the resistor is electrically connected to a switch for momentarily connecting the second terminal of the resistor to the smoothing capacitor.

4. A method for enhancing transient load response characteristics of a switching power converter wherein the switching power converter includes an output smoothing capacitor, comprising:
(a) monitoring an output voltage on the smoothing capacitor;
(b) comparing an instant value of the output voltage to a previous value of the output voltage;
(c) when the instant value of the output voltage exceeds than the previous value of the output voltage by more than a predetermined amount, enabling a supplemental power source wherein said supplemental power source provides additional current to the smoothing capacitor.

5. The method of claim 4 wherein the additional current is a fixed predetermined value.

6. The method of claim 5 wherein the additional current is a calculated value.

7. The method of claim 6 wherein the calculation is of the form:
Current=ΔVo/(ESRc+ΔT/C).

8. The method of claim 4, further comprising the step of disabling the supplemental power source after a certain time period.

9. The method of claim 8 wherein the certain time period is a fixed predetermined time.

10. The method of claim 8 wherein the certain time period is a calculated value.

11. The method of claim 8 wherein the calculation is of the form:
Time=L*Ihc/(Vin−Vo).

12. A method for enhancing transient load response characteristics of a switching power converter wherein the switching power converter includes an output smoothing capacitor, comprising:
(a) monitoring an output voltage on the smoothing capacitor;
(b) comparing an instant value of the output voltage to a previous value of the output voltage;
(c) when the instant value of the output voltage is less than the previous value of the output voltage by more than a predetermined amount, enabling a supplemental power source wherein said supplemental power source removes current from the smoothing capacitor.

13. The method of claim 12 wherein the removed current is a fixed predetermined value.

14. The method of claim 13 wherein the removed current is a calculated value.

15. The method of claim 14 wherein the calculation is of the form:
Current=ΔVo/(ESRc+ΔT/C).

16. The method of claim 12 further comprising the step of disabling the supplemental power source after a certain time period.

17. The method of claim 16 wherein the certain time period is a fixed predetermined time.

18. The method of claim 16 wherein the certain time period is a calculated value.

19. The method of claim 18 wherein the calculation is of the form:
Time=L*Ihc/(Vin−Vo).

20. A method for supplementing current provided to a load by a coil in a switching power converter, comprising: enabling a supplemental current source during the time period in which power is connected to the coil, wherein the supplemental current source is electrically connected to the load.
